(19) United States
(12) Patent Application Publication
(10) Pub. No.: US 2005/0289002 A1
(43) Pub. Date: Dec. 29, 2005

(54) Method, system and computer program product for media content delivery and centralized purchase points

(75) Inventor: John R. Mathis JR., Lacrosse, IN (US)

Correspondence Address: VENABLE LLP, P.O. BOX 34385, WASHINGTON, DC, 20045-9998, US

(73) Assignee: Livemercial Corporation, Valparaiso, IN (US)

(21) Appl. No.: 11/045,519

(22) Filed: Jan. 31, 2005

Related U.S. Application Data
(60) Provisional application No. 60/540,004, filed on Jan. 30, 2004.

(51) Int. Cl. G06F 17/00

(52) U.S. Cl. 705/14

(57) ABSTRACT

A system, method and computer program product for media content delivery and centralized purchase points is disclosed. The system includes media content, user and client databases, and various system components that facilitate the creation of web sites for the delivery of media content as well as the eliciting of responses to options. The options can include commercial advertisements for products and services, and political and charitable information gathering.

### CROSS-REFERENCE TO RELATED APPLICATIONS

This application claims the benefit of U.S. provisional patent application Ser. No. 60/540,004, entitled “Method, System and Computer Program Product for Media Content Delivery and Centralized Purchase Points,” filed Jan. 30, 2004.

### BACKGROUND OF THE INVENTION

Some embodiments of the present invention are generally related to content management systems, and more particularly to computer-based systems that store, select, deliver, present and manage content information.

In today's technological climate, with the availability of low-cost personal computing devices, networking equipment and related technology, media coverage has increased dramatically and changed the way people communicate, shop, and learn. For example, the explosion of people connected to the global Internet has dramatically increased the usage of electronic mail (e-mail) for communications, and the use of browsers to navigate between and view (i.e., browse) documents through the World-Wide Web (WWW), and other Internet-related services. This climate has not only affected personal communications between people, but also communications between consumers and businesses this has come to be known as “e-commerce.”

Further, the technological explosion in the field of wireless telecommunications has brought about numerous new devices that allow people to receive information and communicate with one another. Such devices include mobile phones, wireless application protocol (WAP) devices, personal data assistants (PDAs), interactive television, set-top box enabled devices and the like. These devices, capable of utilizing several communications mediums, as well as linking to the Internet, further harvest the ubiquitous global connectivity achieved by the Internet.

The Internet, along with personal computers, mobile phones, WAP devices, PDAs and the like, owned by today's consumers, each represent an opportunity where business can expose their brands to consumers. These new media are currently not fully exploited, especially within e-commerce activities, to provide users (consumers) with media content about products or services and the ability to purchase them on the devices that they use every day. Computing client applications, through the Internet and wireless devices, offer a unique advantage that has been lacking in traditional media—the ability to interact with a target audience.

Therefore, given the foregoing, a need exists for a system and a method for media content delivery and centralized purchase points. Among other things, the system, method and a computer program product, should allow businesses to use the client applications of consumers to provide this functionality.

### BRIEF DESCRIPTION OF THE DRAWINGS

The invention shall be described with reference to the accompanying figures, wherein:

FIGS. 1-4 illustrate flow diagrams of media content delivery and centralized purchase points, according to embodiments of the present invention;

FIGS. 5-6 illustrates diagrams of system environments capable of being adapted to perform the operations of the present invention, according to embodiments; and

FIG. 7 illustrates a diagram of a computing environment capable of being adapted to perform the operations of present invention, according to an embodiment.

The invention is now described with reference to the accompanying drawings. In the drawings, like reference numbers generally indicate identical, functionally similar, and/or structurally similar elements. The drawing in which an element first appears is generally indicated by the left-most digit(s) in the corresponding reference number.

### DETAILED DESCRIPTION OF PREFERRED EMBODIMENTS

While the present invention is described in terms of the examples below, this is for convenience only and is not intended to limit its application. In fact, after reading the following description, it will be apparent to one of ordinary skill in the art how to implement the following invention in alternative embodiments (e.g., in systems employing Netscape, Mozilla, other Unix-based clients, etc.).

In this detailed description, numerous specific details are set forth. However, it is understood that embodiments of the invention may be practiced without these specific details. In other instances, well-known circuits, structures, and/or techniques have not been shown in detail in order not to obscure an understanding of this description.

References to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

In this detailed description and claims, the term “coupled,” along with its derivatives, such as, “connected” and “electrically connected”, may be used. It should be understood that “coupled” may mean that two or more elements are in direct physical or electrical contact with each other or that the two or more elements are not in direct contact but still cooperate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, as apparent from the following discussions, it is appreciated that throughout the specification discussions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments of the present invention may include apparatuses for performing the operations herein. An apparatus may be specially constructed for the desired purposes, or it may comprise a general purpose device selectively activated or reconfigured by a program stored in the device.

Embodiments of the invention may be implemented in one or a combination of hardware, firmware, and software. Embodiments of the invention may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, etc.), and others.

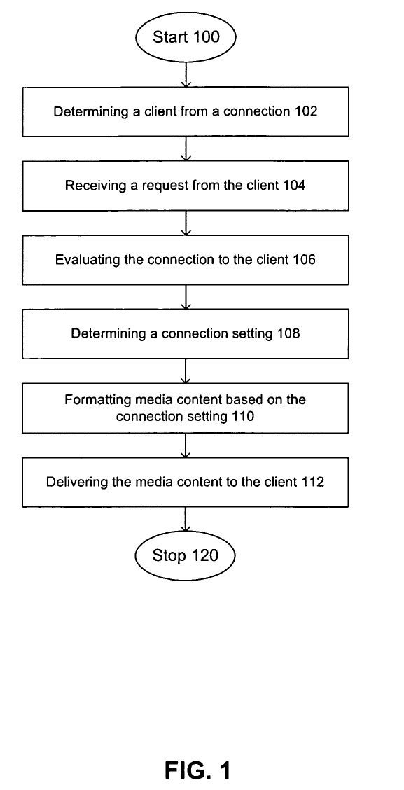

FIG. 1 illustrates a method for delivery of optimized media content, according to one embodiment of the present invention. The process begins at block 100 and immediately proceeds to block 102 for determining a client from a connection from the client to a reference to media content. The process then proceeds to block 104 for receiving a request from the client for the media content. At block 106, the process evaluates the connection to the client. The process then proceeds to block 108 to determine a connection setting for the client. Once the connection setting is determined, the process proceeds to block 110 and formats the media content based on the connection setting. At block 112, the process delivers the media content to the client. The process then proceeds to block 120, where the process ends. At this point the process is able to be repeated and operated in multiple parallel instances, as one of ordinary skill in the art would appreciate, based at least on the teachings provided herein.

According to embodiments of the present invention, the media content is delivered in a video, an audio, and/or an audiovisual format. Furthermore, the connection is made over the Internet, an internet, and/or an intranet. Additionally, the clients may be instantiated on at least one of a palmtop, a set-top box, a gaming console, a personal data assistant device, a mobile phone, a kiosk, and a personal computer.

As one of ordinary skill in the art would recognize, the media content may include service advertisements, product advertisements, political messages, or charitable messages, as well as other topics with information deliverable via the above-described method.

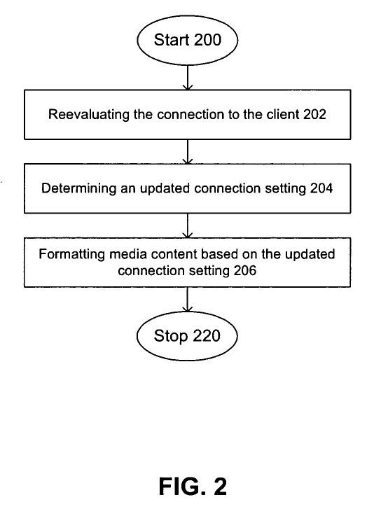

According to embodiments of the present invention, the above-described invention may be supplemented as illustrated in FIG. 2. With respect to FIG. 2, the process beings at block 200, and proceeds immediately to block 202, where it reevaluates the connection to the client at one or more time intervals. The process then proceeds to block 204 to determining an updated connection setting for the client. The process then proceeds to block 206 and formats the media content based on the updated connection setting, wherein the media content continues to be delivered without interruption to the client. The process of FIG. 2, thus, takes into account changes in the client's connection and preserves the stability and consistency of the media content being delivered to the client. The process terminates at block 220 and may be repeated or operated in multiple instances, as described above.

According to embodiments of the present invention, the references which provide access to the media content may include at least one of a universal resource locator (URL), a banner section, a linked image, or a pop-up window.

In additional embodiments of the present invention, an initial portion of the media content is delivered prior to the request from the client. Furthermore, the media content may be delivered in a format reduced and/or compressed more than determined by the connection setting. The media content may be displayed within the client; and the media content may be displayed interactively within an expanding and contracting overlay in the client.

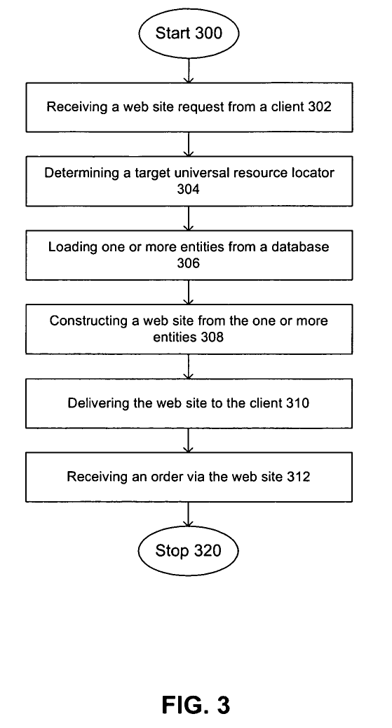

According to embodiments of the present invention, a virtual call center (VCC) may be implemented with a method for providing product related information and access to purchase points, as illustrated in FIG. 3. With respect to FIG. 3, the process starts as block 300 and proceeds to block 302 where it receives a web site request from a client. The process then proceeds to block 304, where it determines a target URL used by the client to send the web site request. In block 306, the process loads one or more entries from a database based on the target URL. The process then proceeds to block 308 and constructs a web site from the one or more entries. The process may then, at block 310 deliver the web site to the client, wherein the web site includes one or more up-sell pipelines. The process may then receive an order from the client via the web site, in block 312. The process then terminates at block 320, and may be repeated alone or with other processes and in parallel with additional processes similar to the process outlined by FIG. 3.

In embodiments of the present invention, the up-sell pipeline may include a configurable tree of options. These options may include at least one of services, products, survey choices, or polling information, or other information, as one skilled in the relevant art(s) would recognized based on the teachings here.

Furthermore, the web site may include one or more media content files which may be accessed as previously described. Alternatively, the up-sell pipelines include one or more down-sell options.

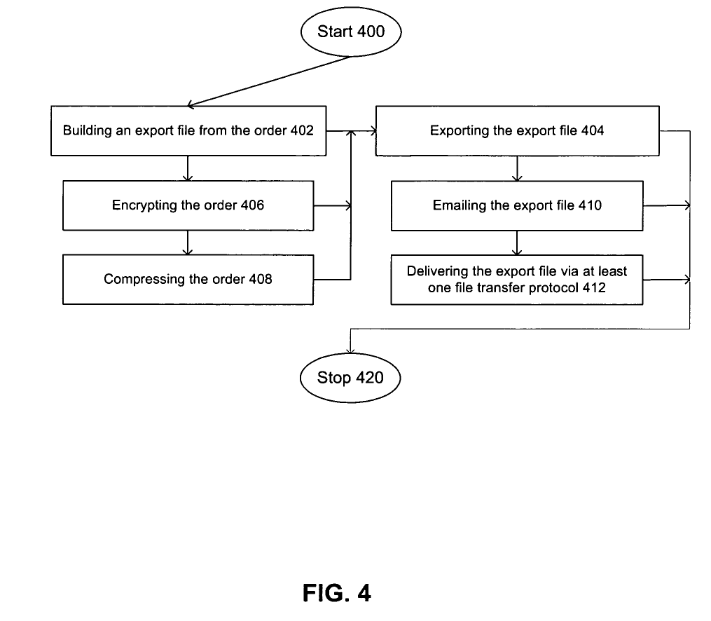

With respect to FIG. 4, the process of FIG. 3 may be added to with the additional operations of FIG. 4. In FIG. 4, the process begins at start 400 and proceeds to building an export file from an order at block 402, such as, but not limited to, the order of FIG. 3. The process then proceeds to block 404 and exports the export file. In embodiments of the present invention, the block 402 may include at least one of: encrypting the export file at block 406; and compressing the export file at block 408. Furthermore, the exporting of block 404 may include at least one of: emailing said export file at block 410 and delivering said export file via at least one file transfer protocol at block 412.

The above embodiments are further described herein. The method for delivery of optimized media content, according to an embodiment of the present invention, may determine a client from a connection from the client to a reference to media content (102) and may receive a request from the client for the media content (104). Further, in an embodiment of the present invention, the method may evaluate the connection to the client (106) and may determine a connection setting for the client (108). The method, according an embodiment of the present invention, may then format the media content based on the connection setting (110) and may deliver the media content to the client (112).

In alternative embodiments, the media content may be delivered in either or all of a video format, an audio format, or an audiovisual format. In further embodiments, the connection may be made over various networks including, but not limited to, the Internet, an internet, or an intranet. To perform the method or parts thereof, the clients may be instantiated on at one or all of a palmtop, a set-top box, a gaming console, a personal data assistant device, a mobile phone, a kiosk, or a personal computer.

According to embodiments of the present invention, the method may involve media content that includes at least one of service advertisements, product advertisements, political messages, or charitable messages.

To maintain the connection with the client or for any other reason such as but not limited to quality control or network routing, the method may reevaluate the connection to said client at one or more time intervals (202) and may determine an updated connection setting for the client (204). According to further embodiments, the method may format the media content based on the updated connection setting, wherein the media content continues to be delivered without interruption to the client (206).

Therefore, in accord with the above embodiments, the references may include at least one of a universal resource locator, a banner section, a linked image, or a pop-up window.

In operation, the method may perform one or more of the following tasks upon the one or more system devices described herein, including, but not limited to delivering an initial portion of the media content prior to the request from the client (302). In this embodiment, various initial portions of media content which are determined to be possible selections/requests are provided the client to reduce the display time of the media content once it is requested. In embodiments of the present invention, the media content is delivered in a format reduced and/or compressed more than determined by the connection setting.

In all of the embodiments of the present invention, the method provides for the media content to be displayed within the client, as well as in embodiments where the media content is displayed interactively within an expanding and contracting overlay in the client.

In an embodiment of the present invention, the method also provides product related information and access to purchase points, by performing some or all of the following operations in the following or similar order. The method may receive a web site request from a client (302), which as described above may include one or more elements of media content in anticipation of determination and selection by the client. Furthermore, the method may determine a target universal resource locator used by the client to send said web site request (304). The method may further including the loading one or more entries from a database based on the target universal resource locator (306) and the constructing of a web site from the one or more entries (308), as described herein. These operations may be performed by the system devices described herein, as one of ordinary skill in the art would appreciate based at least on the teachings described herein. In embodiments of the present invention, the method may then deliver the web site to the client, wherein the web site may includes one or more up-sell pipelines (310); and may then receive an order from the client via the web site (312).

According to embodiments of the present invention, the up-sell pipeline may include a configurable tree of options. These options may include at least one of services, products, survey choices, or polling information. In embodiments of the present invention, these options provide for feedback and responses from the client and are stored and forwarded to the system, as described in the receiving operation (312). In certain embodiments of the present invention, the web site includes media content. In embodiments of the present invention, each up-sell pipeline may include one or more down-sell options. The up-sell pipelines may include one or more additional items for purchase, additional survey questions, or similar options that may follow from the initial option provided with the media content. The down-sell options may include one or more alternative options that follow logically or by design from the choice of the preceding up-sell option.

In an exemplary embodiment, the method of the present invention provides services or operations in the manner of a call center, which may be deployed using an internet. The system of the present invention, operating the method may include a database to store and provide information to the system which provides one or more web sites. The system provides the logic for an up-sell pipeline, and an order export process, described above, which obtains media content from the database. In delivering the media content, the system may utilize the above-describe pre-caching of media content and compression, encryption, and delivery of media content in accord with embodiments of the present invention. As such, the orders are then exported by a configurable database that builds the export files, optionally encrypts them using Pretty Good Privacy (PGP) or other encryption process, optionally compresses the file, and then transmits the file using one of several methods including, but not limited to, email, File Transfer Protocol (FTP), or secure FTP (SFTP).

In such an exemplary embodiment, the orders may be placed through the system devices and the client is then presented with the up-sell pipelines, which include hierarchical trees of products or questions (up-sells and down-sells) that the client may optionally add to the order. The export processes may then transmit the order(s) to either the system itself or directly to a fulfillment center on a schedule determined by the client.

The advantages of delivering options, media content, and orders in accord with the method of the present invention is the dynamic utilization of interactive elements to improve order conversions and build client (customer) confidence. An additional advantages are the increasing the average revenue per order, and the delivery of orders taken for processing and fulfillment. These advantages automate what has been up to now separate and manual processes that included the building of static custom web sites for each product or survey, etc. This process is time consuming to setup and maintain. Further, the exports of the orders are handled through painstaking manual processes which the present invention automates.

According to embodiments of the present invention, the method may further include the building of an export file from the order (402); and the exporting the export file (404). In embodiments, the building of the export file may further include at least one of encrypting said export file (406); and compressing said export file (408). Furthermore, the exporting of the export file may further include at least one of emailing said export file (410); and delivering said export file via at least one file transfer protocol (412).

Systems of the present invention, according to the embodiments discussed herein, may implement the above-described methods, as described in detail below. The present invention is not limited to these architectures, as one of ordinary skill in the art(s) would recognize, based at least on the teachings provided herein.

According to the operating environments discussed below, the process of the present invention, according to the embodiments described above, may be implemented in an apparatus designed to perform these operations.

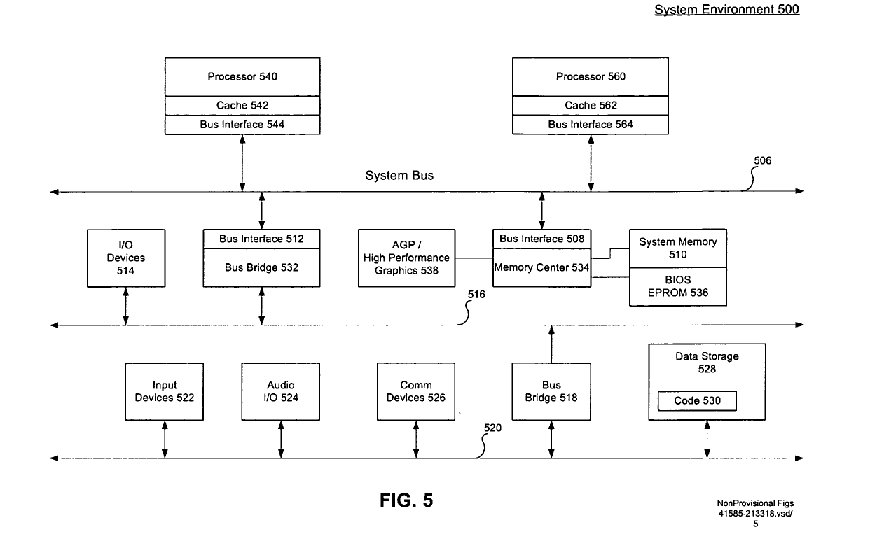

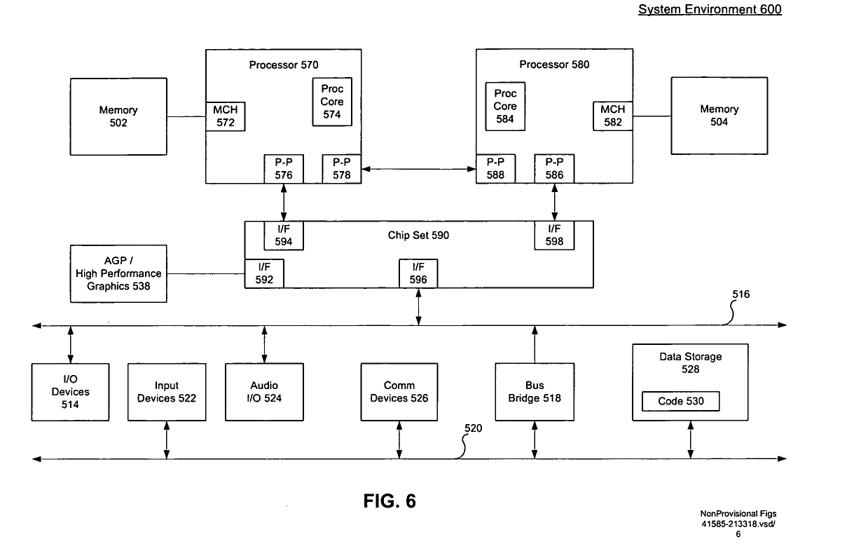

Specifically, and only by way of example, the present invention (i.e., the processes of FIGS. 1-4 or any part thereof) may be implemented using one or more microprocessor architectures or a combination thereof and may be implemented with one or more memory hierarchies. In fact, in one embodiment, the invention may be directed toward one or more processor environments capable of carrying out the functionality described herein. An example of system environments 500 and 600 are shown in FIGS. 5 and 6 and include one or more central processing units, memory units, and buses. The system environments 500 and 600 may include a core logic system chip set that connects a microprocessor to a computing system. Various microprocessor architecture embodiments are described in terms of these exemplary micro-processing and system environments. After reading this description, it will become apparent to a person of ordinary skill in the art how to implement the invention using other micro-processing and/or system environments, based at least on the teachings provided herein.

Referring now to FIGS. 5 and 6, schematic diagrams of systems including a processor supporting execution of speculative threads are shown, according to two embodiments of the present invention. The system environment 500 generally shows a system where processors, memory, and input/output devices may be interconnected by a system bus, whereas the system environment 600 generally shows a system where processors, memory, and input/output devices may be interconnected by a number of point-to-point interfaces.

The system environment 500 may include several processors, of which only two, processors 540, 560 are shown for clarity. Processors 540, 560 may include level one (L1) caches 542, 562. The system environment 500 may have several functions connected via bus interfaces 544, 564, 512, 508 with a system bus 506. In one embodiment, system bus 506 may be the front side bus (FSB) utilized with Pentium™ class microprocessors. In other embodiments, other busses may be used. In some embodiments memory controller 534 and bus bridge 532 may collectively be referred to as a chip set. In some embodiments, functions of a chipset may be divided among physical chips differently from the manner shown in the system environment 500.

Memory controller 534 may permit processors 540, 560 to read and write from system memory 510 and/or from a basic input/output system (BIOS) erasable programmable read-only memory (EPROM) 536. In some embodiments BIOS EPROM 536 may utilize flash memory. Memory controller 534 may include a bus interface 508 to permit memory read and write data to be carried to and from bus agents on system bus 506. Memory controller 534 may also connect with a high-performance graphics circuit 538 across a high-performance graphics interface 539. In certain embodiments the high-performance graphics interface 539 may be an advanced graphics port (AGP) interface. Memory controller 534 may direct read data from system memory 510 to the high-performance graphics circuit 538 across high-performance graphics interface 539.

The system environment 600 may also include several processors, of which only two, processors 570, 580 are shown for clarity. Processors 570, 580 may each include a local memory channel hub (MCH) 572, 582 to connect with memory 502, 504. Processors 570, 580 may exchange data via a point-to-point interface 550 using point-to-point interface circuits 578, 588. Processors 570, 580 may each exchange data with a chipset 590 via individual point-to-point interfaces 552, 554 using point to point interface circuits 576, 594, 586, 598. Chipset 590 may also exchange data with a high-performance graphics circuit 538 via a high-performance graphics interface 592.

In the system environment 500, bus bridge 532 may permit data exchanges between system bus 506 and bus 516, which may in some embodiments be a industry standard architecture (ISA) bus or a peripheral component interconnect (PCI) bus. In the system environment 600, chipset 590 may exchange data with a bus 516 via a bus interface 596. In either system, there may be various input/output I/O devices 514 on the bus 516, including in some embodiments low performance graphics controllers, video controllers, and networking controllers. Another bus bridge 518 may in some embodiments be used to permit data exchanges between bus 516 and bus 520. Bus 520 may in some embodiments be a small computer system interface (SCSI) bus, integrated drive electronics (IDE) bus, or universal serial bus (USB) bus. Additional I/O devices may be connected with bus 520. These may include input devices 522, which may include, but are not limited to, keyboards, pointing devices, and mice, audio I/O 524, communications devices 526, including modems and network interfaces, and data storage devices 528. Software code 530 may be stored on data storage device 528. In some embodiments, data storage device 528 may be, for example, but is not limited to, a fixed magnetic disk, a floppy disk drive, an optical disk drive, a magneto-optical disk drive, a magnetic tape, or non-volatile memory including flash memory.

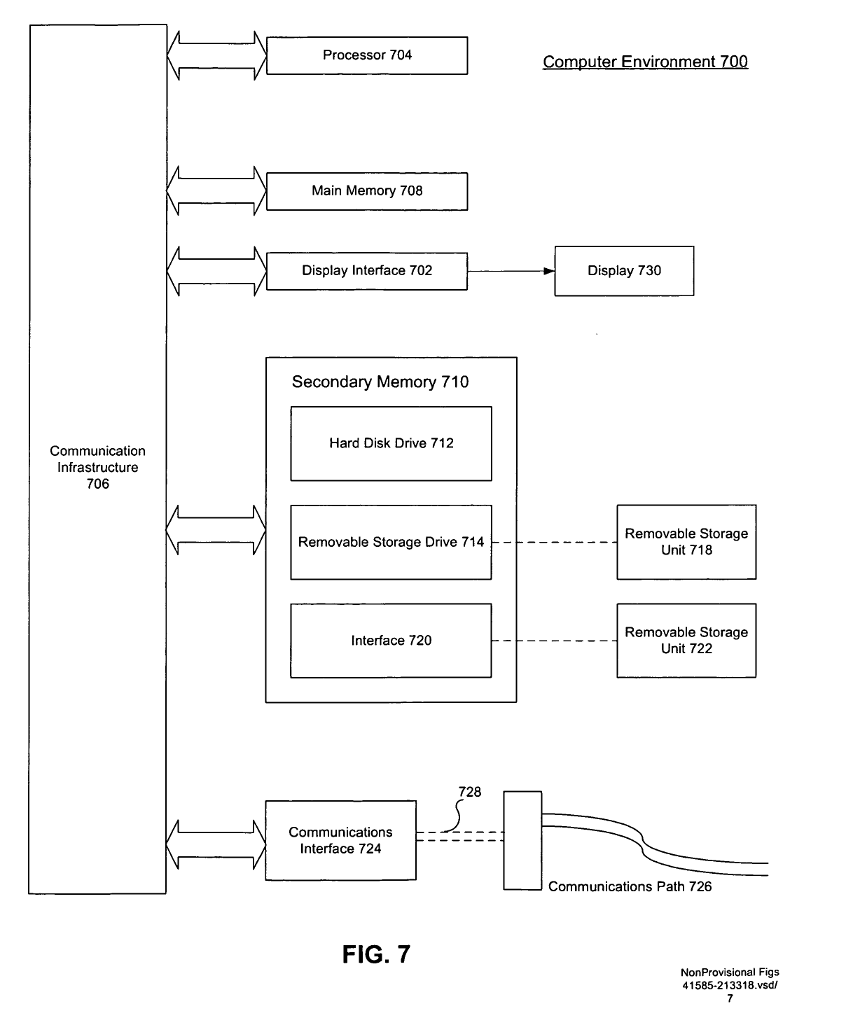

The present invention (i.e., media content delivery, including connection setting evaluation, and centralized purchase points or any part thereof) may be implemented using hardware, software or a combination thereof and may be implemented in one or more computer systems or other processing systems. In fact, in one embodiment, the invention may comprise one or more computer systems capable of carrying out the functionality described herein. An example of a computer system 700 is shown in FIG. 7. The computer system 700 may include one or more processors, such as processor 704. The processor 704 may be connected to a communication infrastructure 706 (e.g., a communications bus, cross over bar, or network). Various software embodiments are described in terms of this exemplary computer system. After reading this description, it will become apparent to a person skilled in the relevant art(s) how to implement the invention using other computer systems and/or computer architectures.

Computer system 700 may include a display interface 702 that may forward graphics, text, and other data from the communication infrastructure 706 (or from a frame buffer not shown) for display on the display unit 730.

Computer system 700 may also include a main memory 708, preferably random access memory (RAM), and may also include a secondary memory 710. The secondary memory 710 may include, for example, a hard disk drive 712 and/or a removable storage drive 714, representing a floppy disk drive, a magnetic tape drive, an optical disk drive, etc, but which is not limited thereto. The removable storage drive 714 may read from and/or write to a removable storage unit 718 in a well known manner. Removable storage unit 718, may represent a floppy disk, magnetic tape, optical disk, etc. which may be read by and written to by removable storage drive 714. As will be appreciated, the removable storage unit 718 may include a computer usable storage medium having stored therein computer software and/or data.

In alternative embodiments, secondary memory 710 may include other similar means for allowing computer programs or other instructions to be loaded into computer system 700. Such means may include, for example, a removable storage unit 722 and an interface 720. Examples of such may include, but are not limited to, a program cartridge and cartridge interface (such as that found in video game devices), a removable memory chip (such as an EPROM, or PROM) and associated socket, and/or other removable storage units 722 and interfaces 720 that may allow software and data to be transferred from the removable storage unit 722 to computer system 700.

Computer system 700 may also include a communications interface 724. Communications interface 724 may allow software and data to be transferred between computer system 700 and external devices. Examples of communications interface 724 may include, but are not limited to, a modem, a network interface (such as an Ethernet card), a communications port, a PCMCIA slot and card, etc. Software and data transferred via communications interface 724 are in the form of signals 728 which may be, for example, electronic, electromagnetic, optical, or other signals capable of being received by communications interface 724. These signals 728 may be provided to communications interface 724 via a communications path (i.e., channel) 726. This channel 726 may carry signals 728 and may be implemented using wire or cable, fiber optics, a phone line, a cellular phone link, an RF link and/or other communications channels.

In this document, the terms “computer program medium” and “computer usable medium” are used to generally refer to media such as, but not limited to, removable storage drive 714, a hard disk installed in hard disk drive 712, and signals 728. These computer program media are means for providing software to computer system 700.

Computer programs (also called computer control logic) may be stored in main memory 708 and/or secondary memory 710. Computer programs may also be received via communications interface 724. Such computer programs, when executed, enable the computer system 700 to perform the features of the present invention as discussed herein. In particular, the computer programs, when executed, may enable the processor 704 to perform the present invention in accordance with the above-described embodiments. Accordingly, such computer programs represent controllers of the computer system 700.

In an embodiment where the invention is implemented using software, the software may be stored in a computer program product and loaded into computer system 700 using, for example, removable storage drive 714, hard drive 712 or communications interface 724. The control logic (software), when executed by the processor 704, causes the processor 704 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s). As discussed above, the invention is implemented using any combination of hardware, firmware and software.

While various embodiments of the invention have been described above, it should be understood that they have been presented by way of example, and not limitation. It will be apparent to persons skilled in the relevant art that various changes in form and detail may be made therein without departing from the spirit and scope of the invention. This is especially true in light of technology and terms within the relevant art(s) that may be later developed. Thus the invention should not be limited by any of the above described exemplary embodiments, but should be defined only in accordance with the following claims and their equivalents.

1. A method for delivery of optimized media content, comprising:
determining a client from a connection from said client to a reference to media content;
receiving a request from said client for said media content;
evaluating said connection to said client;
determining a connection setting for said client;
formatting said media content based on said connection setting; and
delivering said media content to said client.

2. The method of claim 1, wherein said media content is delivered in at least one of a video format, an audio format, or an audiovisual format.

3. The method of claim 1, wherein said connection is made over at least one of the Internet, an internet, or an intranet.

4. The method of claim 1, wherein said clients are instantiated on at least one of a palmtop, a set-top box, a gaming console, a personal data assistant device, a mobile phone, a kiosk, and a personal computer.

5. The method of claim 1, wherein said media content includes at least one of service advertisements, product advertisements, political messages, or charitable messages.

6. The method of claim 1, further comprising:
reevaluating said connection to said client at one or more time intervals;
determining an updated connection setting for said client; and
formatting said media content based on said updated connection setting, wherein said media content continues to be delivered without interruption to said client.

7. The method of claim 1, wherein said references includes at least one of a universal resource locator, a banner section, a linked image, or a pop-up window.

8. The method of claim 1, wherein an initial portion of said media content is delivered prior to said request from said client.

9. The method of claim 1, wherein said media content is delivered in a format reduced and/or compressed more than determined by said connection setting.

10. The method of claim 1, wherein said media content is displayed within said client.

11. The method of claim 10, wherein said media content is displayed interactively within an expanding and contracting overlay in said client.

12. A method for providing product related information and access to purchase points, comprising:
receiving a web site request from a client;
determining a target universal resource locator used by said client to send said web site request;
loading one or more entries from a database based on said target universal resource locator;
constructing a web site from said one or more entries;
delivering said web site to said client, wherein said web site includes one or more up-sell pipelines; and
receiving an order from said client via said web site.

13. The method of claim 12, wherein said up-sell pipeline includes a configurable tree of options.

14. The method of claim 13, wherein said options include at least one of services, products, survey choices, or polling information.

15. The method of claim 12, wherein said web site includes media content.

16. The method of claim 12, wherein said up-sell pipeline includes one or more down-sell options.

17. The method of claim 12, further comprising:
building an export file from said order; and
exporting said export file.

18. The method of claim 17, wherein said building said export file further comprises at least one of:
encrypting said export file; and
compressing said export file.

19. The method of claim 17, wherein said exporting said export file further comprises at least one of:
emailing said export file; and
delivering said export file via at least one file transfer protocol.
